(19) United States
(12) Patent Application Publication
(10) Pub. No.: US 2025/0389958 A1
(43) Pub. Date: Dec. 25, 2025

(54) MIRROR UNIT AND HEAD-UP DISPLAY DEVICE

(71) Applicant: Nippon Seiki Co., Ltd., Niigata (JP)

(72) Inventors: Akitoshi Koshiba, Niigata (JP); Hiroyuki Furusawa, Niigata (JP)

(21) Appl. No.: 19/218,775

(22) Filed: May 27, 2025

(30) Foreign Application Priority Data
Jun. 24, 2024 (JP) 2024-100973

(51) Int. Cl. G02B 27/01; B60K 35/231

(52) U.S. Cl. CPC G02B 27/0149; B60K 35/231; G02B 27/0101; B60K 2360/167; G02B 2027/013; G02B 2027/0154

(57) ABSTRACT

To provide a mirror unit and a head-up display device capable of suppressing deterioration in image quality while further increasing strength with a simple configuration. A mirror unit includes: a substantially rectangular plate-shaped main body plate portion formed of a synthetic resin; a reflection layer that is formed on one surface of the main body plate portion and reflects display light; two shaft portions provided at end portions on both sides in an X direction; and a rib that is erected on the other back surface of the main body plate portion and extends in a rib extending direction V. The rib is formed such that a width of the rib in a direction orthogonal to the rib extending direction V has a length equal to or more than 50% of a thickness of the main body plate portion.

### TECHNICAL FIELD

The present disclosure relates to a mirror unit and a head-up display device.

### BACKGROUND ART

A head-up display device described in Patent Document 1 includes a mirror unit that reflects display light from a display unit onto a front windshield. The mirror unit includes a concave mirror and a holder for supporting the concave mirror from the back surface, the holder is formed in a rectangular plate shape by a synthetic resin, and a plurality of ribs for improving the strength are formed on the back surface of the holder (refer to paragraph 0022 and FIG. 7 of Patent Document 1).

In a concave mirror of a head-up display device described in Patent Document 2, a metal (for example, aluminum) is vapor-deposited on a resin to form a reflection surface (refer to paragraph 0015 of Patent Document 2).

A positioning structure described in Patent Document 3 includes a positioning pin formed of ribs extending in three or four directions from the center. In addition, Patent Document 3 discloses that a sink mark is not generated on a design surface when the widths of the ribs are equal to or less than 50% of the thickness of the design surface (refer to paragraph 0015 of Patent Document 3).

### PRIOR ART DOCUMENT

### Patent Document

Patent Document 1: International Publication No. WO 2019/124331
Patent Document 2: Japanese Unexamined Patent Publication No. 2021-154929
Patent Document 3: Japanese Unexamined Patent Publication No. 2005-277349

### SUMMARY OF INVENTION

### Technical Problem

In the configuration described in Patent Document 1, the concave mirror and the holder are separately manufactured, and the holder is bonded to the concave mirror at adhesive surface sections of the holder. However, the concave mirror and the holder need to be separately configured, and the configuration is not simple.

In the configuration in which the reflection surface is vapor-deposited on the holder described in Patent Document 2, the configuration is simple. However, in this configuration, in a case where ribs are provided, when the widths of the ribs are increased in order to increase the strength, a sink mark is generated, and thus there is a concern that the shape accuracy of the reflection surface and the image quality of a projection image based on reflected display light may be deteriorated.

The present disclosure has been made in view of the above-described circumstances, and an object of the present disclosure is to provide a mirror unit and a head-up display device capable of suppressing deterioration in image quality while further increasing strength with a simple configuration.

### Solution to Problem

In order to achieve the above-described object, a mirror unit according to a first aspect of the present disclosure includes: a substantially rectangular plate-shaped main body plate portion formed of a synthetic resin; a reflection layer that is formed on one surface of the main body plate portion and reflects display light; two shaft portions provided at end portions on both sides of the main body plate portion in a longitudinal direction; and a rib that is erected on the other surface of the main body plate portion and extends in a rib extending direction, in which the rib is formed such that a width of the rib in a direction orthogonal to the rib extending direction has a length equal to or more than 50% of a thickness of the main body plate portion.

In order to achieve the above-described object, a head-up display device according to a second aspect of the present disclosure includes: a display device that emits display light; the mirror unit that reflects the display light; and a mirror drive mechanism that rotates the mirror unit about a rotation axis that passes through the two shaft portions and is inclined with respect to the longitudinal direction.

### Advantageous Effects of Invention

According to the present disclosure, deterioration in image quality can be suppressed while further increasing strength with a simple configuration.

### BRIEF DESCRIPTION OF DRAWINGS

FIG. 1 is a schematic diagram of a vehicle on which a head-up display device according to an embodiment of the present disclosure is mounted.

FIG. 2 is a schematic diagram illustrating a configuration of the head-up display device according to the embodiment of the present disclosure.

FIG. 3 is a perspective view of a mirror unit according to the embodiment of the present disclosure.

FIG. 4 is a perspective view of the mirror unit according to the embodiment of the present disclosure.

FIG. 5 is a plan view of the mirror unit according to the embodiment of the present disclosure.

FIG. 6 is a rear view of the mirror unit according to the embodiment of the present disclosure.

FIG. 7 is a cross-sectional view taken along a line VII-VII of FIG. 4.

FIG. 8 is a perspective view of a mirror unit according to a modification of the present disclosure.

### DESCRIPTION OF EMBODIMENTS

A mirror unit and a head-up display device according to an embodiment of the present disclosure will be described with reference to the drawings.

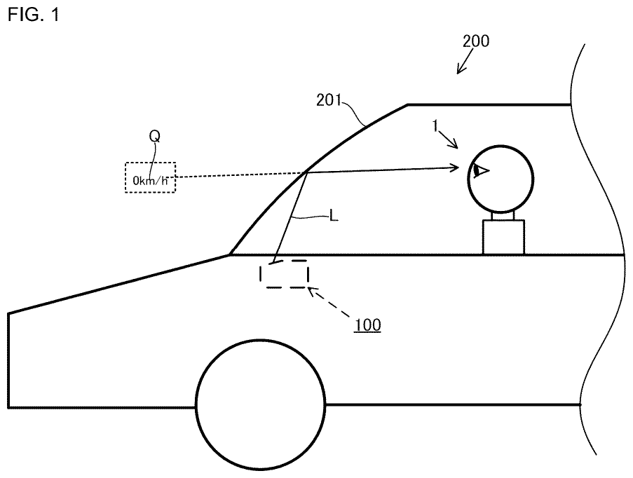

As illustrated in FIG. 1, a head-up display device 100 is installed in a dashboard of a vehicle 200. The head-up display device 100 emits display light L representing an image toward a windshield 201 as an example of a projection target member of the vehicle 200. The display light L is reflected at the windshield 201 and reaches a viewer 1 (mainly a driver of the vehicle 200). Accordingly, the head-up display device 100 displays a virtual image Q so as to be superimposed on the actual view viewed through the windshield 201.

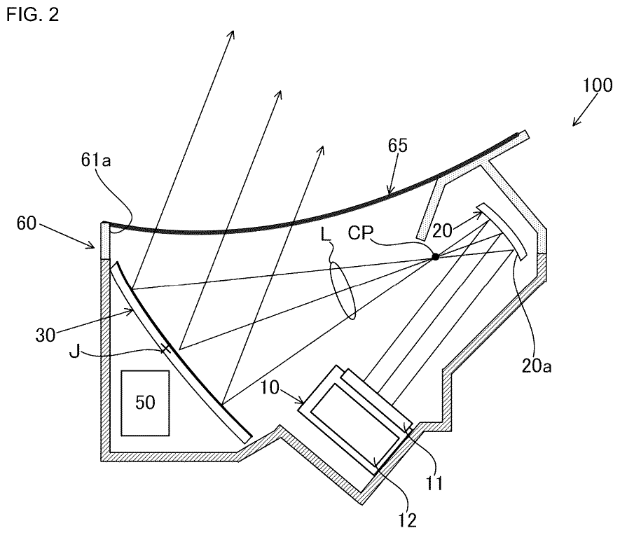

As illustrated in FIG. 2, the head-up display device 100 includes a display device 10, a turning mirror 20, a mirror unit 30, a mirror drive mechanism 50, and a housing 60.

The housing 60 is formed of a non-translucent resin material or a metal material, and has a hollow, substantially rectangular parallelepiped shape. The turning mirror 20, the mirror unit 30, and the mirror drive mechanism 50 are accommodated in the housing 60.

An opening portion 61a is formed in the housing 60 at a position opposed to the windshield 201. The housing 60 includes a curved plate-shaped window portion 65 that closes the opening portion 61a. The window portion 65 is made of a translucent resin material, such as acrylic, through which the display light L passes.

The display device 10 emits the display light L under control by an unillustrated control unit. The display device 10 includes a thin film transistor (TFT) liquid crystal display panel 11 and a backlight 12 that illuminates the display panel 11.

The display device 10 is of a type including the display panel 11, but is not limited thereto, and may be of any type as long as the display device 10 can emit the display light L. The display device 10 may be, for example, of a type including an organic light-emitting diode (OLED) or of a type that receives reflected light by a digital micromirror device (DMD) and displays an image on a transmissive screen.

The turning mirror 20 is a correction mirror and reflects the display light L from the display device 10 toward the mirror unit 30. A reflection surface 20a of the turning mirror 20 forms a convex curved surface in a vehicle width direction, and forms a concave curved surface in a height direction. The reflection surface 20a has a curvature (the reciprocal of a curvature radius) that causes the reflected display light L to vertically cross at a cross point CP before reaching the mirror unit 30.

The turning mirror 20 is not limited to a curved mirror, and may be a flat mirror.

The mirror unit 30 is a concave mirror unit, and reflects the display light L reflected by the turning mirror 20 toward the windshield 201 while enlarging the display light L. A specific configuration of the mirror unit 30 will be described below.

The mirror drive mechanism 50 is configured to be capable of rotating the mirror unit 30 about a rotation axis J extending along the vehicle width direction. When the mirror unit 30 rotates about the rotation axis J, the irradiation position of the display light L with respect to the viewer 1 is adjusted in the height direction.

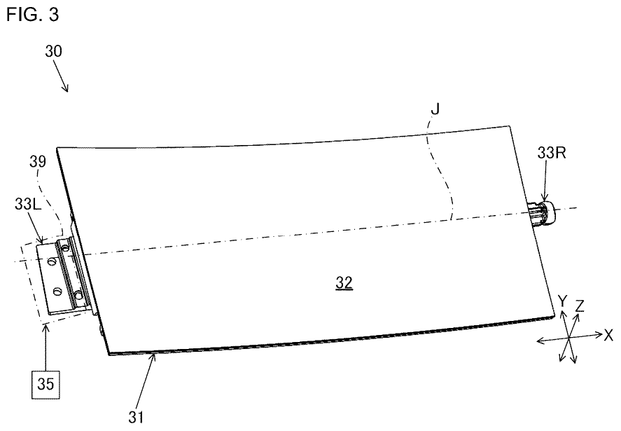

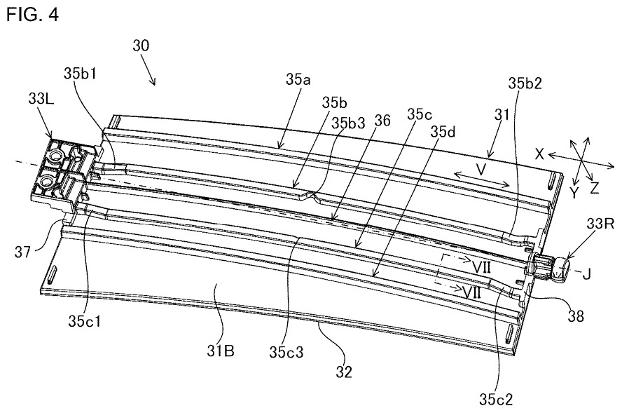

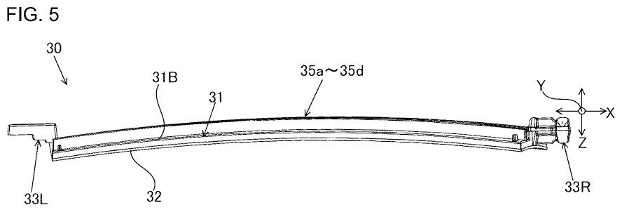

As illustrated in FIGS. 3 to 6, the mirror unit 30 includes a main body plate portion 31, a reflection layer 32, shaft portions 33L and 33R, ribs 35a to 35d, connecting portions 37 and 38, and a plate portion 36.

In the following description, a longitudinal direction of the mirror unit 30 is an X direction, a lateral direction of the mirror unit 30 is a Y direction, and a thickness direction of the mirror unit 30 is a Z direction. The X direction is a direction corresponding to a left-right direction of the virtual image Q as viewed from the viewer 1, that is, the vehicle width direction, the Y direction is a direction corresponding to an up-down direction of the virtual image Q as viewed from the viewer 1, and the Z direction is a direction corresponding to a depth direction of the virtual image Q as viewed from the viewer 1.

In the following description, left and right are defined as directions when a reflection surface of the mirror unit 30 is viewed from the front.

The main body plate portion 31, the shaft portions 33L and 33R, and the ribs 35a to 35d are integrally molded by a synthetic resin as a synthetic resin product. The shaft portion 33L may be formed separately from the main body plate portion 31, the shaft portion 33R, and the ribs 35a to 35d.

The main body plate portion 31 has a substantially rectangular plate shape that is long in the X direction and short in the Y direction. The main body plate portion 31 has a curved shape curved in a concave shape in the X direction and the Y direction.

An upper side surface and a lower side surface of the main body plate portion 31 extend parallel to the X direction.

The reflection layer 32 is formed on a front surface (a surface on the side of the turning mirror 20) of the main body plate portion 31. The reflection layer 32 is formed on the front surface of the main body plate portion 31 by, for example, vapor deposition of a metal such as aluminum.

The shaft portions 33L and 33R are positioned at both ends of the main body plate portion 31 in the X direction.

The shaft portion 33R is positioned at a right side surface of the main body plate portion 31 and has a substantially cylindrical shape extending in the X direction. The shaft portion 33R is positioned above the center of the right side surface of the main body plate portion 31 in the Y direction. The shaft portion 33R is accommodated in an accommodation concave portion (not illustrated) in the housing 60, and in the accommodated state, the shaft portion 33R is biased by a plate spring (not illustrated), so that the shaft portion 33R is rotatably supported in the housing 60.

The shaft portion 33L is positioned at a left side surface of the main body plate portion 31 and has a rectangular plate shape. The shaft portion 33L is positioned below the center of the right side surface of the main body plate portion 31 in the Y direction. A receiving member 39 indicated by a chain line in FIG. 3 is attached to the shaft portion 33L. When the receiving member 39 receives a driving force from the mirror drive mechanism 50, the mirror unit 30 rotates about the rotation axis J.

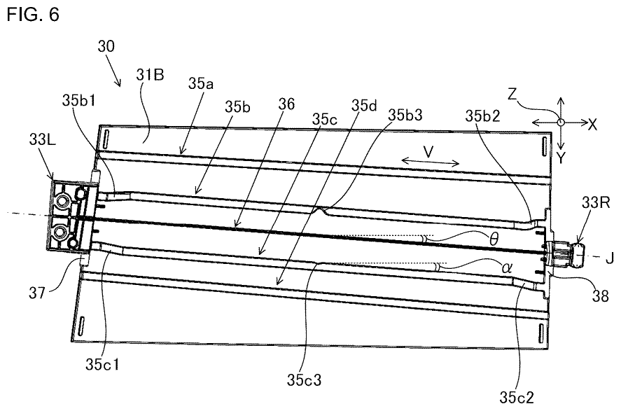

The rotation axis J of the mirror unit 30 is inclined with respect to the X direction. An inclination angle θ (refer to FIG. 6) of the rotation axis J with respect to the X direction is set to 2° to 5°, and preferably about 3.5°.

The ribs 35a to 35d are erected on a back surface 31B (a surface on the opposite side of the reflection layer 32) of the main body plate portion 31.

The ribs 35a to 35d extend in a rib extending direction V. The ribs 35a to 35d are formed so as to traverse the entire region of the back surface 31B of the main body plate portion 31 in the X direction. The ribs 35a to 35d extend so as to be parallel to each other. The rib extending direction V extends in a direction of the rotation axis J and is inclined with respect to the X direction (a direction in which the upper side surface and the lower side surface of the main body plate portion 31 extend). An inclination angle α (refer to FIG. 6) of the rib extending direction V with respect to the X direction is set to 2° to 5°, and preferably about 3.5°.

The ribs 35b and 35c are arranged so as to sandwich the rotation axis J in the Y direction. The ribs 35a and 35d are arranged so as to sandwich the ribs 35b and 35c in the Y direction.

The ribs 35b and 35c include inclined portions 35b1 and 35cl positioned at end portions on the side of the shaft portion 33L in the rib extending direction V. The inclined portions 35b1 and 35cl are inclined so as to be close to the rotation axis J as the inclined portions 35b1 and 35cl are closer to the shaft portion 33L. Outer end portions of the inclined portions 35b1 and 35cl in the rib extending direction V are connected to the connecting portion 37. The connecting portion 37 is positioned at an end portion of the back surface 31B on the side of the shaft portion 33L and has a rectangular parallelepiped shape extending in the Y direction. The ribs 35b and 35c may be formed linearly along the rotation axis J over the entire length without including inclined portions. However, the foregoing inclined portions 35b1 and 35cl may be included in order to avoid a position with which an eject pin is in contact.

The ribs 35b and 35c include inclined portions 35b2 and 35c2 positioned at end portions on the side of the shaft portion 33R in the rib extending direction V. The inclined portions 35b2 and 35c2 are inclined so as to be away from the rotation axis J as the inclined portions 35b2 and 35c2 are closer to the shaft portion 33R. Outer end portions of the inclined portions 35b2 and 35c2 in the X direction are connected to the connecting portion 38. The connecting portion 38 is positioned at an end portion of the back surface 31B on the side of the shaft portion 33R and has a rectangular parallelepiped shape extending in the Y direction. The connecting portion 38 is formed on both sides of a root portion of the shaft portion 33R in the Y direction.

Also in this respect, the ribs 35b and 35c may be formed linearly along the rotation axis J over the entire length without including inclined portions. However, the foregoing inclined portions 35b2 and 35c2 may be included in order to avoid a position with which an eject pin is in contact.

Concave portions 35b3 and 35c3 are formed at the centers of surfaces of the ribs 35b and 35c, which are opposed to each other, in the rib extending direction V. The concave portions 35b3 and 35c3 are formed such that hole widths in the rib extending direction V increase toward the sides opposed to each other. The concave portions 35b3 and 35c3 are portions into which an eject pin (not illustrated) is fitted during injection molding. The eject pin is desirably provided at a position where the eject pin does not interfere with the ribs. In addition, when the eject pin can be provided at a position where the eject pin does not interfere with the ribs, the ribs 35b and 35c are desirably formed linearly along the rotation axis J over the entire length.

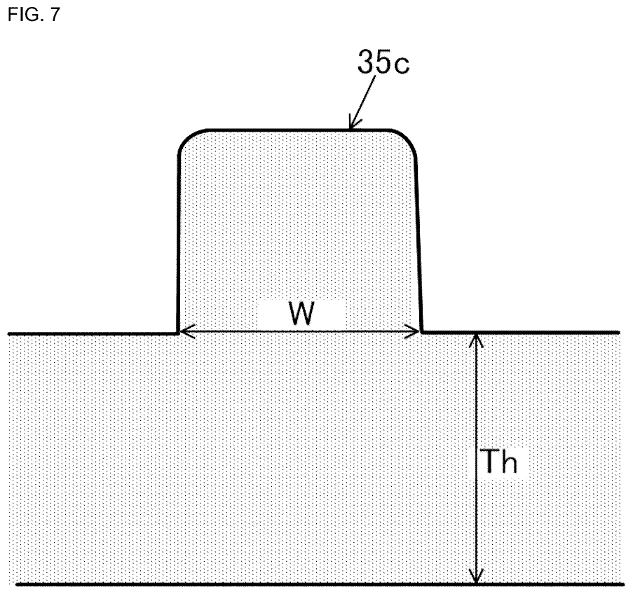

As illustrated in FIG. 7, the rib 35c is formed such that a width W thereof has a length equal to or more than 50% of a plate thickness Th of the main body plate portion 31. The width W of the rib 35c is a length in a direction orthogonal to the rib extending direction V.

The width W of the rib 35c means a width of a root portion of the rib 35c.

The width W of the rib 35c is set to 2 mm to 6 mm, preferably 3.0 mm to 4.5 mm, and more preferably about 3.8 mm.

The plate thickness Th is set to 2 mm to 6 mm, preferably 3.0 mm to 4.5 mm, and more preferably about 3.8 mm.

When the ratio of the width W to the plate thickness Th is too small, the strength of the mirror unit 30 decreases, so that the resonance frequency decreases and vibration is likely to occur. When the ratio is too large, a sink mark may be generated on the surface of the main body plate portion 31.

From this viewpoint, the width W of the rib 35c is set to 50% to 150%, preferably 80% to 120%, more preferably 90% to 110%, and further preferably about 100% of the plate thickness Th of the main body plate portion 31. As an example, the width W and the plate thickness Th are both set to about 3.8 mm.

The widths W of the ribs 35a, 35b, and 35d other than the rib 35c are set in the same manner as the width W of the rib 35c described above.

The heights of the ribs 35a and 35d with reference to the back surface 31B are set to be higher than the heights of the ribs 35b and 35c with reference to the back surface 31B.

The heights of the ribs 35a to 35d may be the same with each other without being limited to the present example.

The plate portion 36 is erected on the back surface 31B and has a plate shape extending on the rotation axis J. The plate portion 36 is formed such that a thickness thereof is smaller than the widths W of the ribs 35a to 35d.

The ribs 35a to 35d and the plate portion 36 are arranged at regular intervals in the Y direction.

As described in Patent Document 3, in the case of forming a rib in a general injection-molded product, unless the rib has a thickness of equal to or less than 50% of the thickness of the injection-molded product, a sink mark is generated on the surface (a surface on the opposite side of the rib) of the injection-molded product in a normal cooling-down period.

In this respect, since cooling-down is performed for a relatively long span of time in the injection molding of the synthetic resin product of the mirror unit 30, even when the wide ribs 35a to 35d having thickness ratios of equal to or more than 50% are formed in order to improve the strength of the mirror unit 30, a sink mark is not generated on the surface of the main body plate portion 31. In other words, a cooling-down period is set to a period during which a sink mark is not generated on the surface of the main body plate portion 31.

Therefore, the strength of the mirror unit 30 is improved without the need for special manufacturing consideration. By improving the strength of the mirror unit 30, the resonance frequency of the mirror unit 30 can be increased, and the vibration of the mirror unit 30 can be suppressed.

### Effects

According to the above-described embodiment, the following effects are achieved.

(1) A mirror unit 30 includes: a substantially rectangular plate-shaped main body plate portion 31 formed of a synthetic resin; a reflection layer 32 that is formed on one surface of the main body plate portion 31 and reflects display light L; two shaft portions 33L and 33R provided at end portions on both sides of the main body plate portion 31 in a longitudinal direction (X direction); and a rib 35a to 35d that is erected on the other back surface 31B of the main body plate portion 31 and extends in a rib extending direction V. The rib 35a to 35d is formed such that a width W of the rib 35a to 35d in a direction orthogonal to the rib extending direction V has a length equal to or more than 50% of a thickness (plate thickness Th) of the main body plate portion 31.

According to this configuration, the configuration is simple because the reflection layer 32 is formed on the main body plate portion 31, the strength of the mirror unit 30 is increased by forming the wide rib 35a to 35d, and a sink mark is not generated as described above. Therefore, the deterioration in image quality of a projection image based on the display light L reflected by the mirror unit 30 can be suppressed.

(2) The mirror unit 30 is capable of rotating about a rotation axis J that passes through the two shaft portions 33L and 33R and is inclined with respect to the X direction. The rib 35a to 35d is formed along a direction of the rotation axis J.

According to this configuration, since the rib 35a to 35d is formed along the direction of the rotation axis J, the strength of the mirror unit 30 is improved.

(3) A head-up display device 100 includes: a display device 10 that emits display light L; the mirror unit 30 that reflects the display light L; and a mirror drive mechanism 50 that rotates the mirror unit 30 about a rotation axis J.

According to this configuration, the deterioration in quality of the projection image (virtual image Q) displayed in the head-up display device 100 can be suppressed.

### Modifications

The above-described embodiment can be implemented in the following modes obtained by appropriately changing the embodiment.

In the above-described embodiment, the positions or shapes of the shaft portions 33L and 33R can be changed. The shaft portions 33L and 33R may be omitted.

In the above-described embodiment, the mirror drive mechanism 50 may be omitted.

In the above-described embodiment, the plate portion 36 may be formed as a rib, or may be omitted.

In the above-described embodiment, the rotation axis J may extend in the X direction.

In the above-described embodiment, the head-up display device 100 is mounted on the vehicle 200, but may be mounted on a conveyance such as an airplane or a ship other than the vehicle 200. In addition, the projection target member is not limited to a front windshield, but may be a dedicated combiner.

In the above-described embodiment, the mirror unit 30 is a concave mirror unit, but may be a flat mirror unit or a free-form surface mirror unit.

In the above-described embodiment, the number, positions, shapes, or widths W of the ribs 35a to 35d can be appropriately changed. The ribs 35a to 35d may extend in the X direction. In this case, the rib extending direction V is the same direction as the X direction. The ribs 35a to 35d may extend in the Y direction on the back surface 31B.

The ribs 35a to 35d may be formed in a curved shape.

Furthermore, for example, the number of the ribs 35a to 35d may be one to three, or five or more.

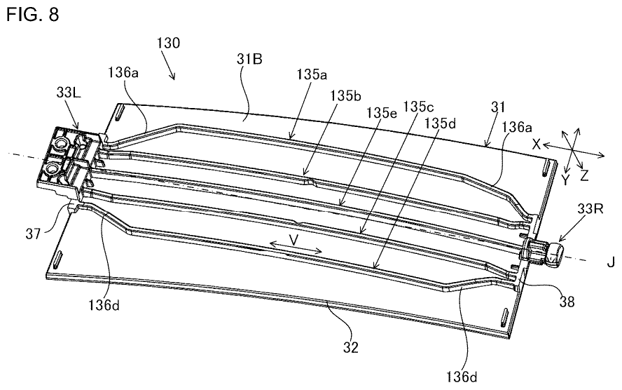

As illustrated in FIG. 8, a mirror unit 130 includes five ribs 135a to 135e, and each of the ribs 135a to 135e extends in the rib extending direction V and is formed so as to be concentrated on the side of the rotation axis J at both ends in the rib extending direction V.

The rib 135e extends on the rotation axis J.

The ribs 135b and 135c are arranged so as to sandwich the rib 135e in the Y direction, and linearly extend in the rib extending direction V on the entire region of the back surface 31B.

The ribs 135a and 135d are arranged so as to sandwich the ribs 135b and 135c in the Y direction. The ribs 135a and 135d include inclined portions 136a and 136d positioned at both ends in the rib extending direction V.

The inclined portions 136a and 136d are inclined toward the rotation axis J as the inclined portions 136a and 136d are closer to both outer sides in the rib extending direction V.

### REFERENCE SIGNS LIST

1 viewer
10 display device
11 display panel
12 backlight
20 turning mirror
20a reflection surface
30, 130 mirror unit
31 main body plate portion
31B back surface
32 reflection layer
33L, 33R shaft portion
35a to 35d, 135a to 135e rib
35b1, 35c1, 35b2, 35c2, 136a, 136d inclined portion
35b3, 35c3 concave portion
36 plate portion
37, 38 connecting portion
39 receiving member
50 mirror drive mechanism
60 housing
61a opening portion
65 window portion
100 head-up display device
200 vehicle
201 windshield
J rotation axis
L display light
V rib extending direction
Q virtual image
CP cross point
Th plate thickness
W width
θ, α inclination angle

1. A mirror unit comprising:
a substantially rectangular plate-shaped main body plate portion formed of a synthetic resin;
a reflection layer that is formed on one surface of the main body plate portion and reflects display light;
two shaft portions provided at end portions on both sides of the main body plate portion in a longitudinal direction; and
a rib that is erected on the other surface of the main body plate portion and extends in a rib extending direction, wherein
the rib is formed such that a width of the rib in a direction orthogonal to the rib extending direction has a length equal to or more than 50% of a thickness of the main body plate portion.

2. The mirror unit according to claim 1, wherein
the mirror unit is capable of rotating about a rotation axis that passes through the two shaft portions and is inclined with respect to the longitudinal direction, and
the rib is formed along a direction of the rotation axis.

3. A head-up display device comprising:
a display device that emits display light;
the mirror unit according to claim 1 that reflects the display light; and
a mirror drive mechanism that rotates the mirror unit about a rotation axis that passes through the two shaft portions and is inclined with respect to the longitudinal direction.
